(19) United States
(12) Patent Application Publication
(10) Pub. No.: US 2010/0141784 A1
(43) Pub. Date: Jun. 10, 2010

(54) MOBILE TERMINAL AND CONTROL METHOD THEREOF

(76) Inventor: Kyung-Hee YOO, Suwon (KR)

Correspondence Address: BIRCH STEWART KOLASCH & BIRCH, PO BOX 747, FALLS CHURCH, VA, 22040-0747, US

(21) Appl. No.: 12/610,014

(22) Filed: Oct. 30, 2009

(30) Foreign Application Priority Data
Dec. 5, 2008 (KR) 10-2008-0123522

(51) Int. Cl. H04N 5/228; H04M 1/00; G09G 5/00; G06K 9/46

(52) U.S. Cl. 348/222.1; 455/556.1; 345/629; 345/660; 382/190; 348/E05.031

(57) ABSTRACT

A terminal for detecting the user's face and performing a special image capturing according to the movement of the user's face, and its control method are provided. The terminal includes a camera configured to receive an image of a subject, a display unit configured to output the received image of the subject and to overlay a pre-determined background image on the received image, and a controller configured to detect a face from the received image of the subject and display the background image based on the size and position of the detected face.

### CROSS-REFERENCE TO RELATED APPLICATIONS

The present application claims priority to Korean Application No. 10-2008-0123522 filed in Korea on Dec. 5, 2008, the entire contents of which is hereby incorporated by reference in its entirety.

### BACKGROUND OF THE INVENTION

1. Field of the Invention

The present invention relates generally to a terminal and a method for controlling the terminal. More particularly, the present invention relates to a terminal for detecting the face in a displayed image and performing a special image capturing according to the movement or orientation of the displayed face, and a control method thereof.

2. Description of Related Art

Terminals may be divided into a mobile terminal (portable terminal) and a stationary terminal according to whether the terminal is portable or not. Mobile terminals may be further divided into a handheld terminal that can be directly carried around and a vehicle mounted terminal.

According to diversification of functions provided by terminals, the terminals may be implemented in the form of multimedia players having complex functions such as capturing images or video, reproducing music or video files, playing games, receiving broadcasts, and the like. In order to support and increase the functions of the terminals, modification of structural parts and/or software parts of the terminals have be taken into consideration.

In general, the function of camera installed in a mobile terminal has an image capture mode to which a special effect can be applied. One of the special effects included in the terminal is capturing an image by overlaying a particular image (e.g., an image without a face part) to a subject. However, with the special effect of capturing an image by overlaying the particular image to a subject, because the shape or size of the particular image is fixed, the user must personally adjust an image capture distance and an image capture direction with respect to the subject according to the size or the shape of the particular image in a preview state, which is quite inconvenient and cumbersome. Here, the image capture distance corresponds to a zooming-in or zooming-out function.

For example, even if the user wants to capture the subject's face such that it is large by zooming in, the size and shape of the overlaid image dictates such that the user has no choice but to capture an image by zooming out the subject's face such that it is small or capture an image in an undesired direction according to the size and shape of the particular overlaid image.

### BRIEF SUMMARY OF THE INVENTION

Accordingly, to overcome one or more of the problems described above, and in accordance with principles of this invention, a terminal is provided. The terminal includes a camera configured to receive an image of a subject, a display unit configured to output the received image of the subject and to overlay a pre-determined background image on the received image, and a controller configured to detect a face from the received image of the subject and display the background image based on the size and position of the detected face

In addition, a method for controlling a terminal is provided. The method includes receiving an image of a subject via a camera, displaying the image of the subject on a screen, detecting a face from the image of the subject, and overlaying a pre-determined background image based on the size and position of the detected face on the displayed image.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention and wherein:

FIG. 1 is a schematic block diagram of a mobile terminal according to an exemplary embodiment of the present invention;

FIG. 2A is a front perspective view of a mobile terminal according to an exemplary embodiment of the present invention;

FIG. 2B is a rear perspective view of the mobile terminal of FIG. 2A;

FIGS. 3A and 3B are front views of the mobile terminal showing operational states of the mobile terminal of FIG. 2A;

FIG. 4 is a schematic view for explaining a proximity depth of a proximity sensor;

FIG. 5 is a flow chart illustrating the process of a control method of a terminal according to an exemplary embodiment of the present invention;

FIG. 6 is an overview of a screen display illustrating a preview screen in a special image capture mode according to an exemplary embodiment of the present invention;

FIG. 7 illustrates the process of selecting a background image from the special image capture mode according to an exemplary embodiment of the present invention;

FIG. 8 illustrates the process of detecting information related to a face from an image of a subject according to an exemplary embodiment of the present invention;

FIG. 9 illustrates the configuration of information related to a background image to be applied to the special image capture mode according to an exemplary embodiment of the present invention;

FIG. 10 illustrates screen displays showing a changing of the position of background images according to the movement of the subject according to an exemplary embodiment of the present invention;

FIG. illustrates screen displays showing a changing of the size of the background images according to an image capture distance of the subject according to an exemplary embodiment of the present invention;

FIGS. 12A and 12B illustrates screen displays showing a changing of the shape of the background images according to a rotation of the subject according to an exemplary embodiment of the present invention; and

FIG. 13 illustrates screen displays showing a plurality of background images corresponding to the number of subjects according to an exemplary embodiment of the present invention.

### DETAILED DESCRIPTION OF THE INVENTION

A terminal according to exemplary embodiments of the present invention will now be described with reference to the accompanying drawings. In the following description, usage of suffixes such as ‘module’, ‘part’ or ‘unit’ used for referring to elements is given merely to facilitate explanation of the present invention, and, as such, is not intended to be limiting.

While the terminal described in the present invention is a portable terminal, which may include mobile phones, smart phones, notebook computers, digital broadcast terminals, Personal Digital Assistants (PDAs), Portable Multimedia Players (PMPs), navigation devices, and the like; except for situations where the configuration according to embodiments of the present invention is applicable only to portable terminals, it is to be understood by that the present invention can be also applicable to the fixed terminals such as digital TVs, desktop computers, and the like.

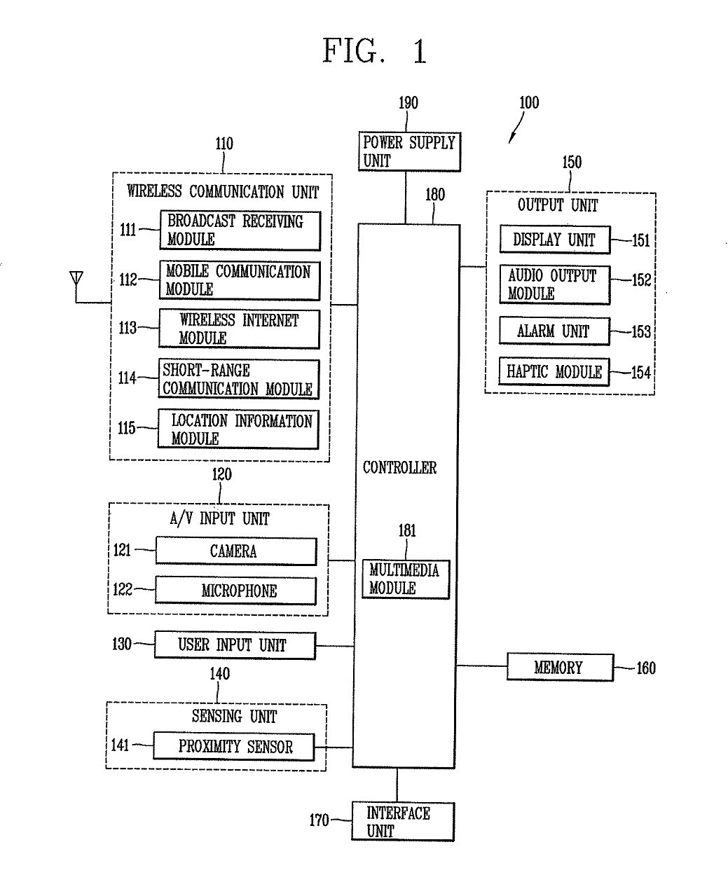

As shown in FIG. 1, a mobile terminal 100 may include a wireless communication unit 110, an Audio/Video (A/V) input unit 120, a user input unit 130, a sensing unit 140, an output unit 150, a memory 160, an interface unit 170, a controller 180, and a power supply unit 190, and the like. The components as shown in FIG. 1 are not all required, therefore greater or fewer components may alternatively be implemented without departing from the scope of the present invention.

The wireless communication unit 110 may include one or more components allowing radio communication between the mobile terminal 100 and a wireless communication system or a network in which the mobile terminal 100 is located. For example, the wireless communication unit 110 may include a broadcast receiving module 111, a mobile communication module 112, a wireless Internet module 113, a short-range communication module 114, and a location information module 115, and the like.

The broadcast receiving module 111 receives broadcast signals and/or broadcast associated information from an external broadcast management server via a broadcast channel. The broadcast channel may include a satellite channel and a terrestrial channel. The broadcast management server may refer to a server that generates and transmits a broadcast signal and/or broadcast associated information or a server that receives a previously generated broadcast signal and/or broadcast associated information and transmits the same to a terminal. The broadcast signal may include not only a TV broadcast signal, a radio broadcast signal and a data broadcast signal, but also a broadcast signal obtained by coupling a data broadcast signal to the TV or radio broadcast signal.

The broadcast associated information may be information related to a broadcast channel, a broadcast program or a broadcast service provider. The broadcast associated information may be provided via a mobile communication network. In this case, the broadcast associated information may be received by the mobile communication module 112. The broadcast associated information may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may receive digital broadcast signals by using digital broadcast systems such as multimedia broadcasting-terrestrial (DMB-T), digital multimedia broadcasting-satellite (DMB-S), media forward link only (MediaFLO®), digital video broadcast-handheld (DVB-H), integrated services digital broadcast-terrestrial (ISDB-T), and the like. The broadcast receiving module 111 may be configured to be suitable for any other broadcast systems as well as the above-described digital broadcast systems. Broadcast signals and/or broadcast-associated information received via the broadcast receiving module 111 may be stored in the memory 160.

The mobile communication module 112 transmits and receives radio signals to and from at least one of a base station, an external terminal, and a server. Such radio signals may include a voice call signal, a video call signal, or various types of data according to text/multimedia message transmission and reception.

The wireless Internet module 113 is a module for a wireless Internet access. This module may be internally or externally coupled to the terminal. The wireless Internet technique may include a Wireless LAN (WLAN), Wi-Fi, Wireless broadband (Wibro), World Interoperability for Microwave Access (Wimax), High Speed Downlink Packet Access (HSDPA), and the like.

The short-range communication module 114 is a module for short-range communication. As the short range communication technologies, BLUETOOTH, radio frequency identification (RFID), infrared data association (IrDA), ultra-wideband (UWB), ZigBee, and the like may be used.

The location information module 115 is a module for checking or acquiring a location of the mobile terminal 100. A GPS (Global Positioning System) module is a typical example of the location information module 115.

With reference to FIG. 1, the A/V input unit 120 is configured to receive an audio or video signal. The A/V input unit 120 may include a camera 121, a microphone 122, and the like. The camera 121 processes image frames of still pictures or video. The processed image frames may be displayed on a display unit 151.

The image frames processed by the camera 121 may be stored in the memory 160 or transmitted via the wireless communication unit 110. Two or more cameras 121 may be provided according to a usage environment.

The microphone 122 receives an external audio signal while in a phone call mode, a recording mode, a voice recognition mode, and the like, and processes the external audio signal into electrical audio data. The processed audio data may be converted for output into a format transmittable to a mobile communication base station via the mobile communication module 112 in case of the phone call mode. The microphone 122 may include various types of noise canceling algorithms to cancel noise generated in the course of receiving and transmitting external audio signals.

The user input unit 130 generates input data to control an operation of the mobile terminal 100. The user input unit 130 may include a keypad, a dome switch, a touch pad (e.g., static pressure or capacitance), a jog wheel, a jog switch, and the like.

The sensing unit 140 detects a current status of the mobile terminal 100 such as an opened or closed state of the mobile terminal 100, a location of the mobile terminal 100, a presence or absence of user contact with the mobile terminal 100, orientation of the mobile terminal 100, an acceleration or deceleration movement of the mobile terminal 100, and the like, and generates a sensing signal for controlling the operation of the mobile terminal 100. For example, when the mobile terminal is a slide type mobile phone, the sensing unit 140 may sense whether the slide phone is opened or closed. In addition, the sensing unit 140 can detect whether or not the power supply unit 190 supplies power or whether or not the interface unit 170 is coupled to an external device. The sensing unit 140 may include a proximity sensor 141.

The output unit 150 generates an output related to the sense of sight, the sense of hearing, or the sense of touch and may include the display unit 151, the audio output module 152, the alarm unit 153, and a haptic module 154.

The display unit 151 displays (outputs) information processed in the mobile terminal 100. For example, when the mobile terminal 100 is in a phone call mode, the display unit 151 displays a User Interface (UI) or a Graphic User Interface (GUI) associated with a call. When the mobile terminal 100 is in a video call mode or image capturing mode, the display unit 151 may display a captured image and/or received image, a UI or GUI. The display unit 151 may include at least one of a Liquid Crystal Display (LCD), a Thin Film Transistor-LCD (TFT-LCD), an Organic Light Emitting Diode (OLED), a flexible display and a three-dimensional (3D) display.

Some of displays may be configured to be transparent to allow viewing of the exterior therethrough, which may be called transparent displays. A typical transparent display may be, for example, a Transparent Organic Light Emitting Diode (TOLED), or the like. The rear structure of the display unit 151 may include a light transmissive structure. With such a structure, the user can view an object located at a rear side of the terminal body through the region occupied by the display unit 151 of the terminal body.

The mobile terminal may include two or more display units according to a particular embodiment. For example, a plurality of display units may be separately or integrally disposed on one surface or disposed on both surfaces of the mobile terminal, respectively.

When the display unit 151 and a sensor (referred to as a ‘touch sensor’, hereinafter) are overlaid in a layered manner (referred to as a ‘touch screen’, hereinafter), the display unit 151 may be used as both an input device and an output device. The touch sensor may have the form of, for example, a touch film, a touch sheet, a touch pad, or the like. The touch sensor may be configured to convert a pressure applied to a particular portion of the display unit 151 or a change in capacitance at a particular portion of the display unit 151 into an electrical input signal. The touch sensor may be configured to detect the pressure when a touch is applied, as well as a touched position or area.

When a touch with respect to the touch sensor is inputted, corresponding signal (signals) are transmitted to a touch controller. The touch controller processes the signal (signals) and transmits corresponding data to the controller 180. Thus, the controller 180 can recognize which portion of the display unit 151 has been touched.

With reference to FIG. 1, a proximity sensor 141 may be disposed within the mobile terminal 100 covered by the touch screen or near the touch screen. The proximity sensor 141 refers to a sensor for detecting the presence or absence of an object that manipulates a certain detect surface or an object that exists nearby by using the force of electromagnetism or infrared rays without a mechanical contact. Thus, the proximity sensor 141 has a longer life span compared with a contact type sensor, and it can be utilized for various purposes. An example of the proximity sensor 141 may be a transmission type photoelectric sensor, a direct reflection type photoelectric sensor, a mirror-reflection type photoelectric sensor, an RF oscillation type proximity sensor, a capacitance type proximity sensor, a magnetic proximity sensor, an infrared proximity sensor. When the touch screen is an electrostatic type touch screen, an approach of the pointer is detected based on a change in an electric field according to the approach of the pointer. In this case, the touch screen (touch sensor) may be classified as a proximity sensor.

In the following description, for the sake of brevity, recognition of the pointer positioned to be close to the touch screen without being contacted will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

The proximity sensor 141 detects a proximity touch and a proximity touch pattern (e.g., a proximity touch distance, a proximity touch speed, a proximity touch time, a proximity touch position, a proximity touch movement state, or the like), and information corresponding to the detected proximity touch operation and the proximity touch pattern can be outputted to the touch screen.

The audio output module 152 may output audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function (e.g., a call signal reception sound, a message reception sound, and the like.) performed in the mobile terminal 100. The audio output module 152 may include a receiver, a speaker, a buzzer, and the like.

The alarm unit 153 outputs a signal for informing about an occurrence of an event of the mobile terminal 100. Events generated in the mobile terminal 100 may include call signal reception, message reception, key signal inputs, a touch input, and the like. In addition to video or audio signals, the alarm unit 153 may output signals in a different manner, for example, to inform about an occurrence of an event. The video or audio signals may be also outputted via the audio output module 152, therefore the display unit 151 and the audio output module 152 may be classified as parts of the alarm unit 153.

A haptic module 154 generates various tactile effects the user may feel. A typical example of the tactile effects generated by the haptic module 154 is vibration. The strength and pattern of the haptic module 154 can be controlled. For example, different vibrations may be coupled to be outputted or sequentially outputted. Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, and the like. In addition, the haptic module 154 can generate an effect by reproducing the sense of cold and warmth using an element that can absorb or generate heat. The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the mobile terminal.

The memory 160 may store software programs used for the processing and controlling operations performed by the controller 180, or may temporarily store data (e.g., a phonebook, messages, still images, video, and the like) that are inputted or outputted. In addition, the memory 160 may store data regarding various patterns of vibrations and audio signals outputted when a touch is inputted to the touch screen. The memory 160 may include at least one type of storage medium including a Flash memory, a hard disk, a multimedia card micro type, a card-type memory (e.g., SD or DX memory, and the like), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with external devices connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like. The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via a port.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal 100 is properly mounted on the cradle.

The controller 180 typically controls the general operations of the mobile terminal 100. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180. The controller 180 may perform a pattern recognition processing to recognize a handwritten input or a picture drawing input performed on the touch screen as characters or images, respectively.

The power supply unit 190 receives external power or internal power and supplies appropriate power required for operating respective elements and components under the control of the controller 180.

Various embodiments of the various units of the mobile terminal 100 described herein may be implemented in a computer-readable or its similar medium using, for example, software, hardware, or any combination thereof. For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic units designed to perform the functions described herein. In some terminals, such embodiments may be implemented by the controller 180. For software implementation, the embodiments such as procedures or functions may be implemented together with separate software modules that allow performing of at least one function or operation. Software codes can be implemented by a software application (or program) written in any suitable programming language. The software codes may be stored in the memory 160 and executed by the controller 180.

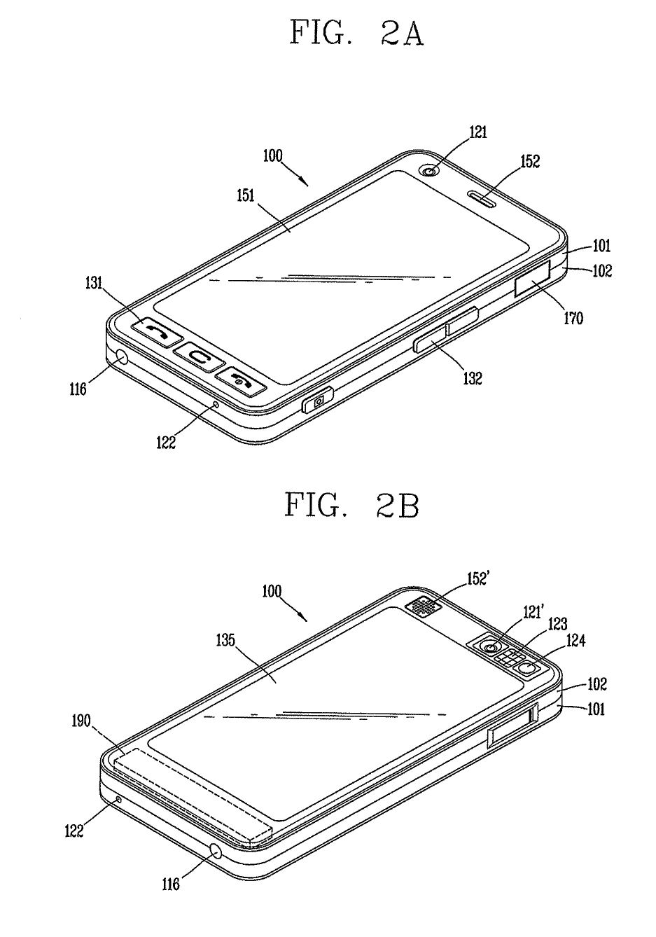

As shown in FIG. 2A, the mobile terminal 100 has a bar type terminal body. However, the present invention is not limited thereto and may be applicable to a slide type mobile terminal, a folder type mobile terminal, a swing type mobile terminal, a swivel type mobile terminal, and the like, in which two or more bodies are coupled to be relatively movable.

The body includes a case (or casing, housing, cover, and the like.) constituting the external appearance. In this exemplary embodiment, the case may include a front case 101 and a rear case 102. Various electronic components are installed in the space between the front case 101 and the rear case 102. One or more intermediate cases may be additionally disposed between the front case 101 and the rear case 102. The cases may be formed by injection-molding a synthetic resin or may be made of a metallic material such as stainless steel (STS) or titanium (Ti), and the like.

The display unit 151, the audio output module 152, the camera 121, the user input unit 130, 131, 132, the microphone 122, the interface unit 170, and the like may be disposed mainly on the front case 101.

In this exemplary embodiment, the display unit 151 covers most of an upper surface of the front case 101. The audio output unit 151 and the camera 121 are disposed at a region adjacent to one end portion of the display unit 151, and the user input unit 131 and the microphone 122 are disposed at a region adjacent an opposite end portion. The user input unit 132 and the interface unit 170 may be disposed at the sides of the front case 101 and the rear case 102.

The user input unit 130 is manipulated to receive a command for controlling the operation of the mobile terminal 100 and may include a plurality of manipulation units 131 and 132. The manipulation units 131 and 132 may be generally referred to as a manipulating portion, and various methods and techniques can be employed for the manipulation portion so long as they can be operated by the user in a tactile manner. Content inputted by the first and second manipulation units 131 and 132 can be variably set. For example, the first manipulation unit 131 may receive a command such as starting, ending, scrolling, and the like, and the second manipulation unit 32 may receive a command such as controlling of the size of a sound outputted from the audio output unit 152 or conversion into a touch recognition mode of the display unit 151.

With reference to FIG. 2B, a camera 121′ may additionally be disposed on the rear surface of the terminal body, namely, on the rear case 102. The camera 121′ may have an image capture direction which is substantially opposite of that of the camera 121 (See FIG. 2A), and have a different number of pixels than the camera 121. For example, the camera 121 may have a smaller number of pixels to capture an image of the user's face and transmit such image to another party, and the camera 121′ may have a larger number of pixels to capture an image of a general object and not immediately transmit it in most cases. The cameras 121 and 121′ may be installed on the terminal body such that they can be rotatable or popped up.

A flash 123 and a mirror 124 may be additionally disposed adjacent to the camera 121′. When an image of a subject is captured with the camera 121′, the flash 123 illuminates the subject. The mirror 124 allows the user to see himself when he wants to capture his own image (self-image capturing) by using the camera 121′.

An audio output unit 152′ may be additionally disposed on the rear surface of the terminal body. The audio output module 152′ may implement stereophonic sound functions in conjunction with the audio output module 152 (See FIG. 2A) and may be also used for implementing a speaker phone mode for call communication.

A broadcast signal receiving antenna 124 may be disposed at the side of the terminal body, in addition to an antenna that is used for mobile communications. The antenna 124 constituting a portion of the broadcast receiving module 111 (See FIG. 1) can also be configured to be retractable from the terminal body.

The power supply unit 190 for supplying power to the mobile terminal 100 is mounted on the terminal body. The power supply unit 190 may be installed within the terminal body or may be directly attached to or detached from the exterior of the terminal body.

A touch pad 135 for detecting a touch may be mounted on the rear case 102. The touch pad 135 may be configured to be light transmissive like the display unit 151. In this case, when the display unit 151 is configured to output visual information from both sides thereof, the visual information may be recognized also via the touch pad 135. Alternatively, a display may be additionally mounted on the touch pad so that a touch screen may be disposed on the rear case 102. The touch pad 135 is operated in association with the display unit 151 of the front case 101. The touch pad 135 may be disposed to be parallel on the rear side of the display unit 151. The touch pad 135 may be the same size as the display unit 151 or smaller.

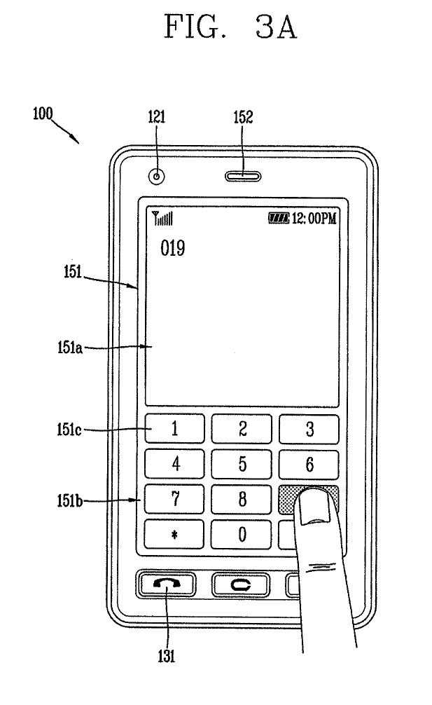

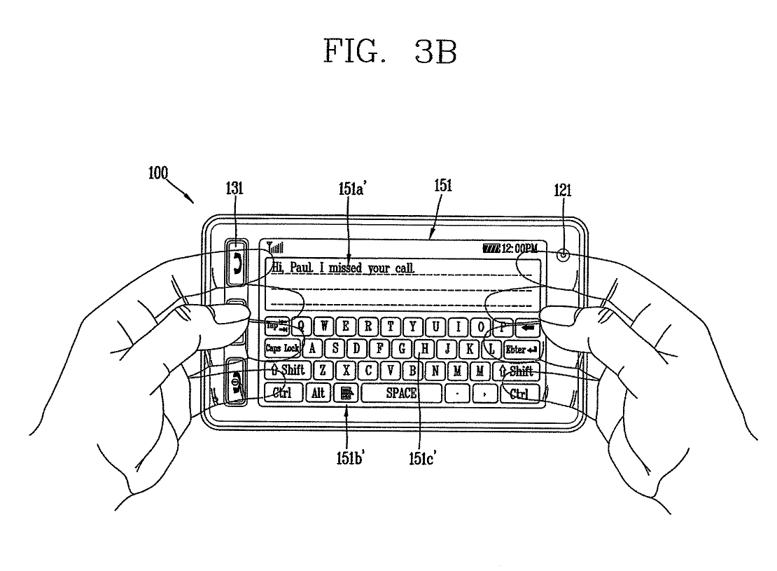

Various types of visual information may be displayed on the display unit 151. The information may be displayed in the form of character, number, symbol, graphic, icon, and the like. In order to input the information, at least one of the character, number, symbol, graphic and icon is displayed in a certain arrangement so as to be implemented in the form of a keypad. Such keypad may be a so-called ‘soft key’. FIG. 3A shows mobile terminal 100 receiving a touch applied to a soft key on the front surface of the terminal body.

The display unit 151 may be operated as a whole region or may be divided into a plurality of regions and operated accordingly. In the latter case, the plurality of regions may be operated in association with each other. For example, an output window 151 a and an input window 151b may be displayed at upper and lower portions of the display unit 151, respectively. The output window 151a and the input window 151b are allocated to output or input information, respectively. Soft keys 151c including numbers for inputting a phone number or the like are outputted on the input window 151b. When the soft key 151c is touched, a number corresponding to the touched soft key is displayed on the output window 151a. When the first manipulation unit 131 is manipulated, a call connection with respect to a phone number displayed on the output window 151a is attempted.

FIG. 3B shows the mobile terminal 100 receiving of a touch applied to the soft key through the rear surface of the terminal body. While FIG. 3A shows a portrait in which the terminal body is disposed vertically, FIG. 3B shows a landscape in which the terminal body is disposed horizontally. The display unit 151 may be configured to convert an output screen image according to the disposition direction of the terminal body.

In addition, FIG. 3B shows an operation of a text input mode in the mobile terminal 100. An output window 151a′ and an input window 151b′ are displayed on the display unit 151. A plurality of soft keys 151c′ including at least one of characters, symbols and numbers may be arranged on the input window 151b′. The soft keys 151c′ may be arranged in the form of QWERTY keys. When the soft keys 151c′ are touched through the touch pad 135 (See FIG. 2B), characters, numbers, symbols, or the like, corresponding to the touched soft keys are displayed on the output window 151a′. Compared with a touch input through the display unit 151, a touch input through the touch pad 135 can advantageously prevent the soft keys 151c′ from being covered by user's fingers when touching is made. When the display unit 151 and the touch pad 135 are formed to be transparent, the user's fingers put on the rear surface of the terminal body can be viewed with naked eyes, so the touch input can be more accurately performed.

Besides the input methods presented in the above-described embodiments, the display unit 151 or the touch pad 135 may be configured to receive a touch through scrolling. The user may move a cursor or a pointer positioned on an entity, e.g., an icon or the like, displayed on the display unit 151 by scrolling the display unit 151 or the touch pad 135. In addition, when the user moves his fingers on the display unit 151 or the touch pad 135, the path along which the user's fingers move may be visually displayed on the display unit 151. This would be useful in editing an image displayed on the display unit 151.

One function of the terminal may be executed in case where the display unit 151 (touch screen) and the touch pad 135 are touched together within a certain time range. The both touches may be clamping the terminal body with the user's thumb and index finger. The one function may be, for example, activation or deactivation of the display unit 151 or the touch pad 135.

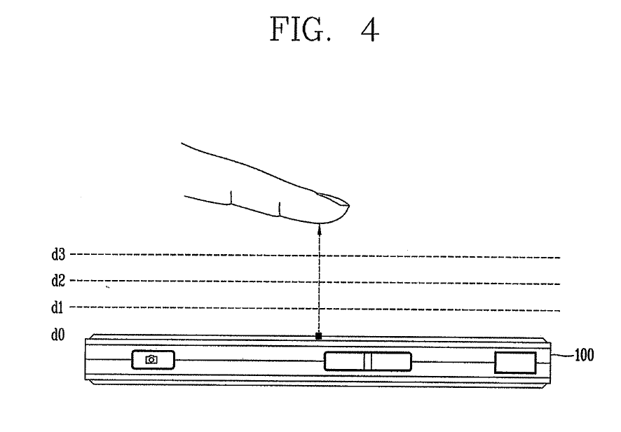

As shown in FIG. 4, when a pointer such as the user's finger, a pen, or the like, approaches the touch screen, the proximity sensor 141 disposed within or near the touch screen detects it and outputs a proximity signal. The proximity sensor 141 may be configured to output a different proximity signal according to the distance (referred to as a ‘proximity depth’, hereinafter) between the closely touched pointer and the touch screen. For example, as shown in FIG. 4, three proximity depths are provided

In detail, when the pointer is completely brought into contact with the touch screen at level d0, it is recognized as a contact touch. When the pointer is positioned to be spaced apart by shorter than a distance d1 on the touch screen, it is recognized as a proximity touch with a first proximity depth. If the pointer is positioned to be spaced apart by the distance longer than the distance d1 but shorter than a distance d2 on the touch screen, it is recognized as a proximity touch with a second proximity depth. If the pointer is positioned to be spaced apart by the distance longer than the distance d2 but shorter than a distance d3, it is recognized as a proximity touch with a third proximity depth. If the pointer is positioned to be spaced apart by longer than the distance d3 on the touch screen, it is recognized that the proximity touch has been released. It is understood, that while three proximity depths are provided, various numbers of proximity depths including three or less or four or more may be provided.

Accordingly, the controller 180 may recognize the proximity touches as various input signals according to the proximity depths and proximity positions of the pointer, and may control various operations according to the various input signals.

A control method that may be implemented in the terminal configured as described above according to exemplary embodiments of the present invention will now be explained with reference to the accompanying drawings. The exemplary embodiments to be described hereinbelow may be solely used or combined to be used. Also, the exemplary embodiments described hereinbelow may be combined with the UE as described above so as to be used.

The present invention relates to an image capturing method of a terminal having a camera function and, more particularly, to a special image capturing method capable of capturing an image by overlaying a particular background image to a subject. Thus, hereinafter, it is assumed that the terminal executes the camera function, in particular, the special image capturing function.

In the present exemplary embodiment, it is assumed that the terminal enters the special image capturing mode (or the special image capturing function has been executed). In particular, it is assumed that among various special image capture modes, a mode in which image capturing is performed by overlaying a particular background image on a subject is executed. For example, the particular background image may be an image of small pieces that can ornament or decorate the subject, including glasses, wigs, clothes, hats, beard, accessories, photo frames, and the like.

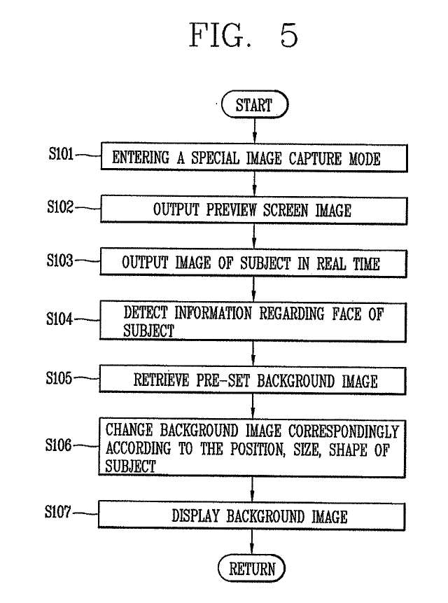

As shown in FIG. 5, when the terminal enters the special image capture mode (S101), the controller 180 outputs a preview screen (S102). The controller 180 outputs an image inputted via the camera 121 to the preview screen (referred to as a ‘subject image’, hereinafter) in real time (S103). When there is a pre-determined or pre-set particular background image set for the special image capture mode, the controller 180 also outputs the pre-set background image in real time. In this exemplary embodiment, the background image may be displayed as an upper layer over the subject image. In addition, a portion (or a partial region) of the background image may be set as a lower layer than the subject image, or a portion (or a partial region) of the background image may be transparently displayed.

In this exemplary embodiment, the background image provided in the special image capture mode may be set such that its display position, size or shape correspond to a particular part of the subject. For example, if the background image is assumed to be glasses, it may be set such that a central portion of lenses of the glasses corresponds to the eyes of the subject's face. If the background image is a wig, it may be set such that the position of the wig corresponds to the forehead of the subject's face. It may be set such that the size of shape of the background image corresponds to the size or a contour of the face.

The information corresponding to a particular portion of the subject's face may be included in each background image so as to be provided. Thus, the controller 180 may automatically change the size, shape or position of the background image according to the movement, size or shape of the subject with reference to the information corresponding to a particular portion of the subject's face.

The controller 180 detects information related to a face from the subject image (S104). As the information related to the face, only contour information may be simply detected or detailed information related to the face may be detected.

For example, as the detailed information related to the face, one of information regarding the size (e.g., horizontal and vertical lengths) of the face, the position and size of the nose, the position and size of eyes, the position and size of the ear, the position and size of the mouth, the position and size of the forehead, the position and size of the jaw may be detected. In addition, the direction in which the subject's face is oriented may be detected based on the detected information. Also, the number of subjects may be detected by determining the number of faces.

After such information is detected, the controller 180 retrieves the pre-set background image from the memory 160 (S105). And the controller 180 analyzes information (e.g., information for changing the display position, size, or shape of the background image, or information corresponding to a certain part of the face) set for the background image.

The controller 180 automatically changes the display position, size, or shape of the retrieved background image correspondingly according to the display position, size, or shape of the retrieved background image to the position, size, and shape (or contour) of the subject's face (S106). Namely, the controller 180 displays the pre-set background image based on the subject's face, and displays the changed background image on a preview screen (S107).

In this exemplary embodiment, if the subject moves, the controller 180 may track the subject's movement and automatically change and display the position of the background image. If the direction in which the subjects points to, or the shape or size of the subject's face is changed when the subject moves, the controller 180 may automatically change and display the shape or size of the background image. If the subject is zoomed (e.g., digitally zoomed) or optically zoomed, the controller 180 may tract the position, size, shape of the subject's face and automatically change and display the shape, size or display position of the background image.

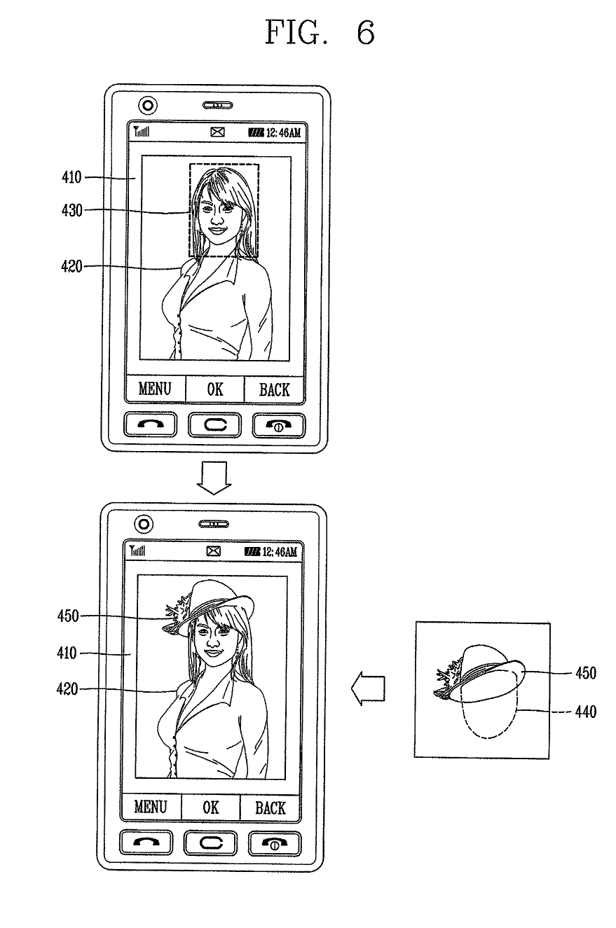

As shown in FIG. 6, after the terminal enters the special image capture mode, the controller 180 outputs the subject's image 420 inputted through the camera 121 to a preview screen 410. And then, the controller 180 detects a face from the subject's image. After detecting the face, the controller 180 may display the contour of the face by using a frame 430 in a particular shape (e.g., rectangular shape).

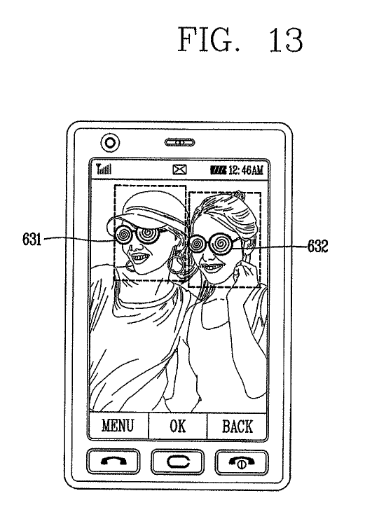

If two or more faces are detected from the subject's image, the controller 180 may display a corresponding number of frames (See FIG. 13). And, the controller 180 may continuously track the face of the subject. Namely, the controller 180 may move the frame displaying the contour of the face according to the movement of the face.

The controller 180 retrieves a particular background image 450 set for the special image capture mode from the memory 160 and outputs it along with the subject's image to the preview screen. When the user views preview screen 410, the background image is displayed at an upper layer of the subject's image in the preview screen 410. In order for the certain part (e.g., the face part) of the subject's image 520 is seen to the user, the particular part 440 of the background image 450 may be displayed to be transparent.

In the related art, because the size, shape, and position of the background image are fixed, the user must capture the subject by adjusting the direction and distance (or zooming) of the camera such that it fits the transparent part of the background image. In contrast, in the present invention, the size, shape and position of the background image are automatically changed according to the size, shape and position of the subject whose image is captured by the user. Thus, the user can freely capture the image of the subject as desired without being dependent upon the background image.

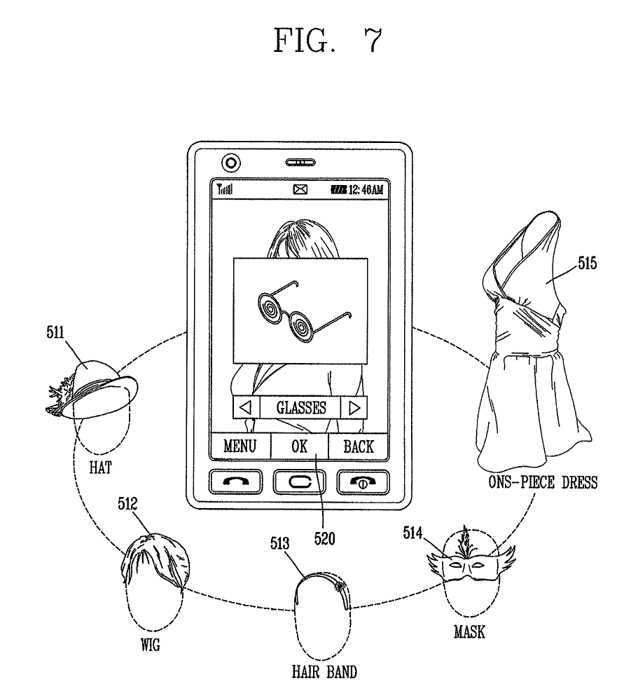

As shown in FIG. 7, the process of selecting a background image from the special image capture mode according to an exemplary embodiment of the present invention is provided. After the terminal enters the special image capture mode, the user may display a background image list and select one of several background images as desired from the list. In the menu for selecting the background image, a background image set as a default may be displayed regardless of the size, shape and position of the subject image input via the camera 121. Specifically, the background image is set as a default without changing the size, shape, or position of the background image according to the size, shape, or position of the subject image. Accordingly, the user can easily select the desired background image. It is understood that the background image may be immediately applied to the subject image and displayed, but the method of changing the background image correspondingly according to the subject image falls within the technical content of the present invention, so a detailed description thereof will be omitted.

For example, the user sequentially displays background images 511 to 515 by pressing a soft key, a hard key, or through a touch input. When a background image desired by the user is displayed, the user presses a pre-set particular key (e.g., an OK key) 520. When the background image is selected, the background image selection menu (or the background image list) disappears, and the controller 180 outputs the selected background image to the preview screen. The size, shape and position of the background image output to the preview screen are automatically changed according to the size, shape or position of the subject image.

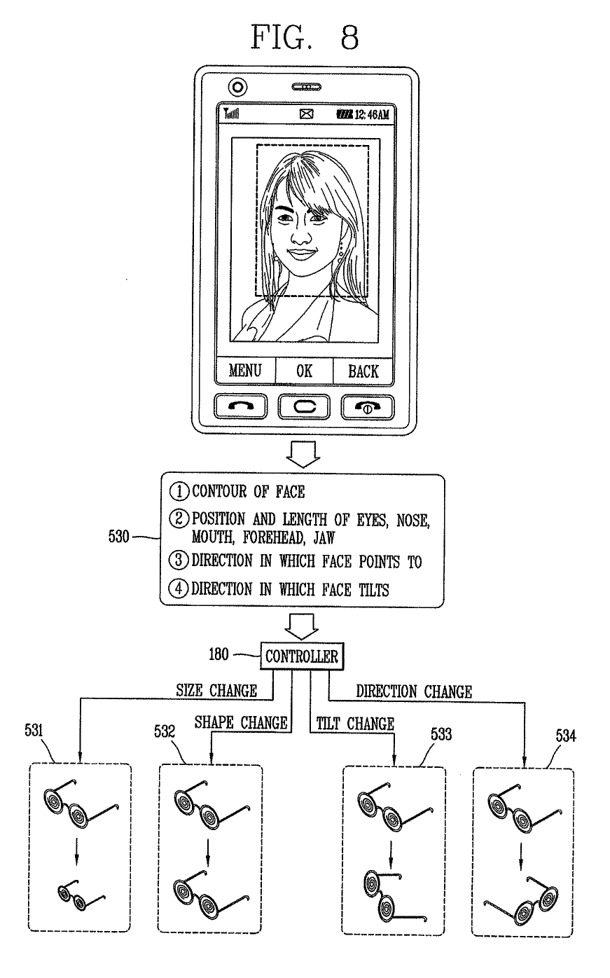

The method of changing the size, shape or position of the background image according to the image of the subject will now be described in more detail. As shown in FIG. 8, the process of detecting information related to the face from the image of the subject according to an exemplary embodiment of the present invention will now be described. When the image of the subject is captured by the camera 121, the controller 180 can detect the contour of the face from the image of the subject as described above. In an exemplary embodiment of the present invention, the shape, size, or display position of the background image can be simply controlled by detecting the contour of the face. For example, if a background image (e.g., glasses, wigs, hair band, hat, and the like) related to the face is combined with the face of the subject, the eyes, nose, mouth and ears are generally disposed at similar positions. While there are slight differences depending on the features of individual people, there is no difficulty in combining the background image to the image of the subject.

However, if more detailed information 530 related to the face of the subject is detected, the shape or size of the background image may be precisely changed according the face shape (or contour) of the subject or a direction in which the face of the subject is oriented. For example, position, length, or tilt information of the contour, eyes, nose, mouth, forehead or jaw is detected from the face of the subject, based on the direction in which the face of the subject points to or the direction in which the face of the subject is inclined.

In this manner, the controller 180 may change the size of the background image (531) in the direction in which the shape or the size of the face detected from the image of the subject or in the direction in which the face points to or the face is inclined, change the shape of the background image (532), tilt the background image (533), rotate the background image (534), or change the length of each side of the background image corresponding to a certain part of the face.

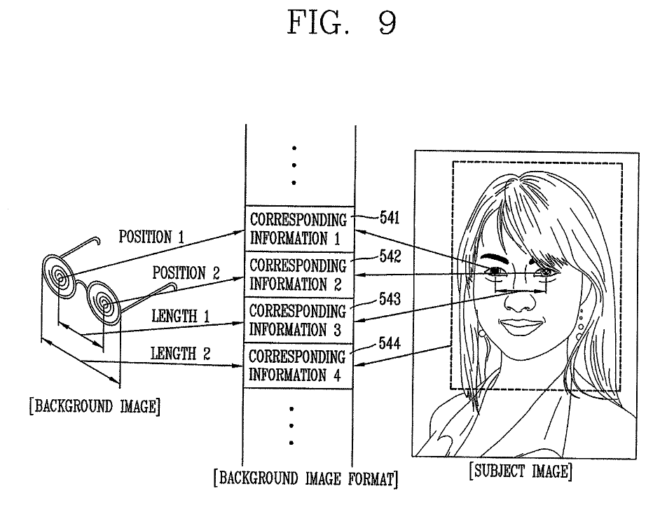

Meanwhile, despite the contour of the face or information of each element of the face is detected, if the background image does not include information corresponding to the information of each element, the shape or size of the background image cannot be changed. Thus, the process of detecting the information related to the background image will now be described with reference to FIG. 9.

The background image may be configured as a vector image or a bit map image. By using a vector image, it is possible to prevent a step phenomenon when magnifying or reducing the background image. In addition, the background image may be configured as a two-dimensional image (e.g., planar image) or a three-dimensional image (e.g., stereoscopic image). In this case, a three-dimensional image is preferred to expose a portion which has not been exposed in case of changing the background image according to the direction in which the face of the subject points to or the direction in which the face of the subject is inclined.

The background image includes information 541 to 544 matched to the face in order to change the shape, size, or display direction corresponding to the face. For example, the corresponding information 541 to 544 may include information for magnifying or reducing the background image according to the size of the face. Namely, the background image includes information about a horizontal length and a vertical length corresponding to the size of the face of the subject.

The background image may further include contour information including a particular shape (e.g., an oval shape). For example, if the size of the face of the subject is increased, the size of the background image is increased correspondingly according to the size of the face of the subject according to the horizontal length and the vertical length of the contour of the face.

The background image may include position information corresponding to a certain part of the face of the subject. The position information may be used to display a background image only when a certain part of the face of the subject is visible or may be used to change the size, shape, or tilt of the background image.

The background image may include two or more position information, and each position information may include information about the length in a particular direction. Namely, the background image may include only position information as a reference or length information connecting two positions. For example, on the assumption that the background image is glasses and a central position of the lenses of the glasses is set as a position corresponding to the eyes of the face of the subject, if the face of the subject is inclined to onside, one of the eyes would tilt down and the lens corresponding to the eye would tilt accordingly, and thus, the size of one lens may be altered to be larger correspondingly according to the distance to the eyes and the contour of the face.

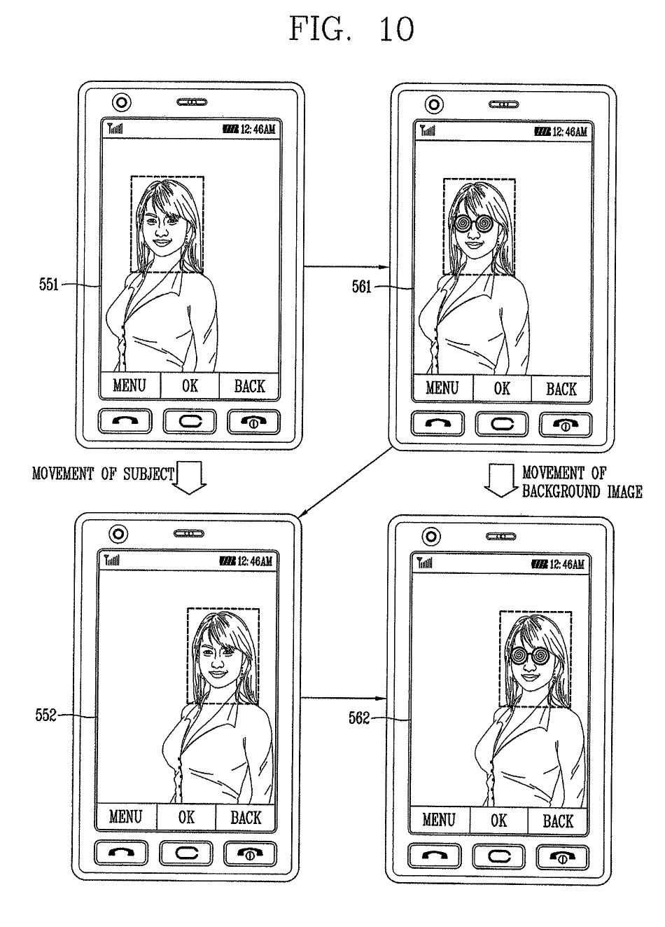

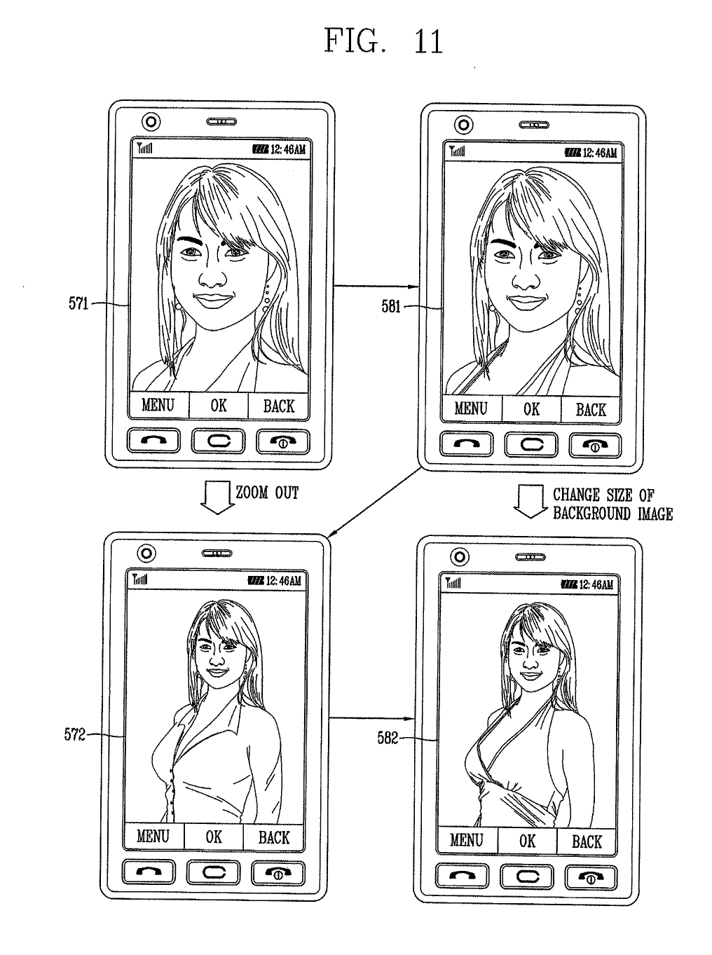

The method of automatically changing the background images according to each situation when the special image capturing is executed according to an exemplary embodiment of the present invention will now be described. For example, changing of the position of a background image according to the movement of the subject according to an exemplary embodiment of the present invention will be described with reference to FIG. 10.

As shown, a preview screen image is displayed on the display module 151, and when the subject is moved (551 to 552) on the preview screen image, the controller 180 detects the face of the subject and tracks the movement of the face. Namely, the controller 180 detects the direction in which the face moves and the distance, and moves the background image by the detected direction and distance to display it (561 to 562). In this case, the background image may be displayed in real time while the subject is moving, but in consideration of the calculation processing capability of the terminal which is not high, the background image may be displayed when the movement of the subject is paused.

Changing of the size of the background images according to an image capture distance of the subject according to an exemplary embodiment of the present invention will described with reference to FIG. 11. If the user moves the camera closer to the subject or if the user executes a zooming-in function, the image of the subject is scaled up and displayed. Conversely, if the user moves the camera away from the subject or if the user executes a zooming-out function, the image of the subject is scaled down and displayed. Accordingly, when the subject is zoomed in, the preview screen would be full with the face of the subject, while when the subject is zoomed out, an upper or lower part of the subject could be displayed on the preview screen.

For example, using clothes as the background image (e.g., a one-piece dress), if the subject is zoomed in, the image of the subject is scaled up, and accordingly, the background image is also magnified or increased. Thus, a portion of the background image magnified to be larger than the preview screen is not displayed. If the subject is zoomed out (571 to 572), the image of the subject is scaled down, and accordingly, the background image is reduced, so the portion of the background image which was not displayed when magnified can be displayed (581 to 582). Namely, in the zoom-in state, the display range of the background image displayed on the preview screen is reduced so only the background image near the face is displayed, but when the zoom-in state is changed to the zoom-out state, the display range of the background image displayed on the preview screen is increased, so the background image can be displayed from the face to the upper or lower part of the subject.

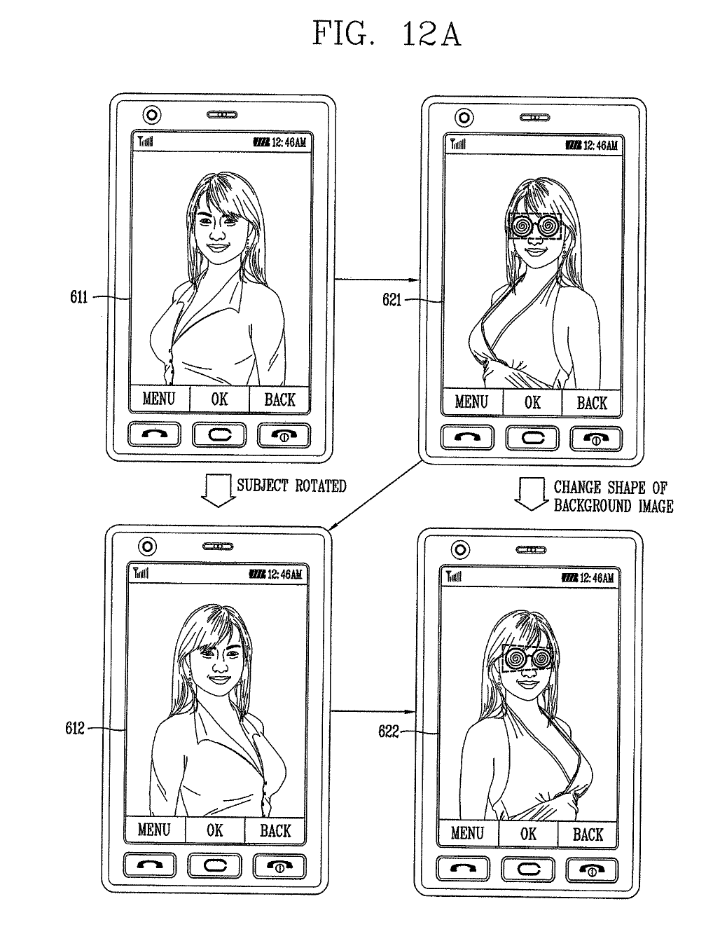

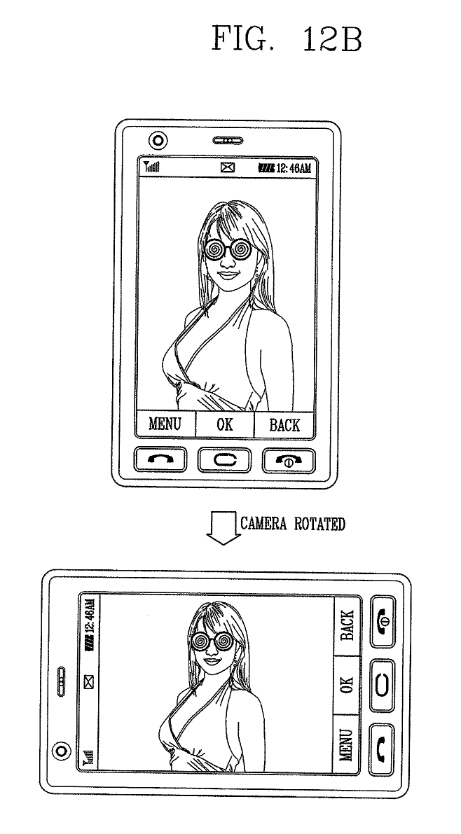

Changing of the shape of the background images according to a rotation of the subject according to an exemplary embodiment of the present invention will be described with reference to FIGS. 12A and 12B. The rotation of the subject may occur when the subject rotates left or right at a certain angle or when the image capture direction of the camera is moved from the front to the side at a certain angle. When the subject rotates, the elements of the face are inclined to the direction in which the face points to. Namely, the direction in which the face points to may be determined based on the positions of the elements of the face. In the present exemplary embodiment, even when the subject turns his face to one side from a state of viewing the front side or tilts his face, the subject is regarded as being rotated.

When the subject rotates in that manner (611 to 612), the controller 180 detects the rotational direction and the rotational distance (or the rotational angle) of the subject. The rotational direction and the rotational angle may be roughly detected by using the information 530 related to the face. And, according to the detected rotational direction, one side of the background image may be magnified to be larger than the other side or reduced to be smaller than the other side so as to be displayed (621 to 622), or one side of the background image may be displayed to be tilted up or down compared with the other side.

Also, the rotation of the subject may occur when the camera is rotated from a vertical direction to a horizontal direction or vice versa. As shown in FIG. 12B, when the camera is rotated from the vertical direction to the horizontal direction or from the horizontal direction to the vertical direction, the controller 180 detects the position of the camera by using the contour of the face and rotates the background image according to the detected position. Even when the camera is tilted at a certain angle, not just in the horizontal direction or in the vertical direction, the controller 180 may rotate and display the background image.

Whether the subject moves or the camera is moved, the position of the camera refers to a direction in which the subject is displayed on the preview screen image. Specifically, the position of the camera may substantially refer to the posture of the subject. Thus, there is no need to detect the position of the camera by using the sensing unit 140. Rather, the background image can be displayed by detecting the posture of the subject in the image regardless of the angle at which the camera 121 is rotated.

As shown in FIG. 13, when an image of two or more people is captured, the controller 180 may detect the face of each of the subjects. It is also understood that the controller 180 may track the movement of each face. The controller 180 may display background images corresponding to the number of detected faces. When the plurality of background images 631 and 632 are displayed, the size, shape, color, or layer of each background image can be randomly outputted. Namely, when the plurality of background images are displayed in an overlapping manner, the size, shape, or color of each background image may be displayed differently according to the faces of the subjects. A background image on a lower layer may be displayed to be covered by a background image on a higher layer.

As so far described, the terminal according to the exemplary embodiments of the present invention has the following advantages. When special image capturing is performed by using a particular background image, a person's face can be detected from the subject's image, and the size, shape, position, or movement of the background image can be automatically changed to be displayed, thus improving a user convenience.

In addition, when special image capturing is performed by using a particular background image, the number of background images can be automatically adjusted to be displayed according to the number of persons captured as subjects.

As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

1. A terminal comprising:
a camera configured to receive an image of a subject;
a display unit configured to output the received image of the subject and to overlay a pre-determined background image on the received image; and
a controller configured to detect a face from the received image of the subject and display the background image based on the size and position of the detected face.

2. The terminal of claim 1, wherein the controller detects at least one of information about the position and the length of at least one element of the face, information about the size of the face, and information about the contour of the face from the detected face.

3. The terminal of claim 2, wherein the at least one element of the face is one of eyes, nose, mouth, ears, forehead, and jaw.

4. The terminal of claim 1, wherein the controller detects a movement of the face, and changes and displays the position of the background image according to the movement of the face.

5. The terminal of claim 1, wherein the controller detects the size of the face and changes and displays the size of the background image according to the detected size.

6. The terminal of claim 1, wherein the controller increases or reduces the size of the background image as the subject is zoomed in or zoomed out, respectively, to displaying the background image.

7. The terminal of claim 1, wherein the controller determines the direction in which the face points and changes the shape of the background image according to the direction of the face.

8. The terminal of claim 1, wherein, if two or more faces are detected, the controller is configured to display the background image based on the face of each subject.

9. The terminal of claim 1, wherein the terminal is a portable terminal.

10. The terminal of claim 9, wherein the portable terminal is a cellular phone.

11. A method for controlling a terminal, the method comprising:
receiving an image of a subject via a camera;
displaying the image of the subject on a screen;
detecting a face from the image of the subject; and
overlaying a pre-determined background image based on the size and position of the detected face on the displayed image.

12. The method of claim 11, further comprising:
when the face is detected, detecting information regarding the face.

13. The method of claim 12, wherein the information related to the face includes at least one of information about the position and the length of at least one element of the face, information about the size of the face, and information about the contour of the face from the detected face.

14. The method of claim 13, wherein the at least one element of the face is one of eyes, nose, mouth, ears, forehead, and jaw.

15. The method of claim 11, wherein, in overlaying the background image, the position of the background image is automatically changed and displayed according to a movement of the face.

16. The method of claim 11, wherein, in overlaying the background image, the size of the background image is automatically changed to be displayed according to the size of the face.

17. The method of claim 11, wherein the size of the background image is automatically increased or reduced as the subject is zoomed in or zoomed out, respectively.

18. The method of claim 11, further comprising:
when the face is detected, displaying the contour of the face in a particular shape of frame.

19. The method of claim 11, further comprising:
if two or more faces are detected, each background image is overlaid based on the face of each subject.

20. The method of claim 11, wherein the terminal is a portable terminal.
